(19) United States
(12) Patent Application Publication
(10) Pub. No.: US 2012/0241075 A1
(43) Pub. Date: Sep. 27, 2012

(54) METHOD OF PASTING A PLURALITY OF OBJECTS AND PASTING MACHINE

(75) Inventor: Ching-Hsiu Hsu, Taoyuan County (TW)

(73) Assignee: CHUNGHWA PICTURE TUBES, LTD., Taoyuan (TW)

(21) Appl. No.: 13/149,915

(22) Filed: Jun. 1, 2011

(30) Foreign Application Priority Data
Mar. 24, 2011 (TW) 100110155

(51) Int. Cl. B32B 37/12; B05C 5/02

(52) U.S. Cl. 156/64; 156/356

(57) ABSTRACT

A method of pasting a plurality of objects is provided, comprising: at least providing a first object having first alignment marks and a second object having second alignment marks, placing the first object and the second object in parallel, and aligning the first alignment marks and the second alignment marks. Thereafter, applying a first adhesive on the first object and the second object to form a frame pattern temporarily fixing the first object and the second object while the first object and the second object are aligned. A first filling space is defined by the first object, the second object, and the frame pattern. The frame pattern has an injection hole and an exhausting hole at two opposite sides. A second adhesive fills the filling space to paste the first object on the second object. A viscosity of the first adhesive is larger than a viscosity of the second adhesive.

### CROSS-REFERENCE TO RELATED APPLICATION

This application claims the priority benefit of Taiwan application serial no. 100110155, filed Mar. 24, 2011. The entirety of the above-mentioned patent application is hereby incorporated by reference herein and made a part of this specification.

### BACKGROUND OF THE INVENTION

1. Field of the Invention

The invention is related to a pasting method and more particularly to a method of pasting a plurality of objects.

2. Description of Related Art

With the vigorous development of the display technology, the displays have not only the displaying function but also have further functions such as 3D (three-dimensions) displaying function, touch sensing function, etc. During the fabrication of such displays having multi-functions, the pasting process is required to be performed several times so that the objects having alternative functions are combined with the display panel. In a conventional pasting process, the first object and the second object to be pasted are placed on a platform, and are subsequently aligned to each other. Thereafter, a UV (ultraviolet) curing adhesive is applied on the first object and then the first object and the second object are pasted through the UV curing adhesive. Once a high level display having both the 3D displaying function and the touch sensing function is fabricated, the pasting process mentioned above is performed at least three times so that the cover lens, the touch panel, the 2D (two dimensions) to 3D switching panel, and the display panel are combined. The fabrication of the display as mentioned above has the disadvantages of time consumption and high fabricating cost, which renders the display lacking of competitiveness.

### SUMMARY OF THE INVENTION

The invention provides a method of pasting a plurality of objects, wherein a plurality of objects can be simultaneously pasted, which is conducive to reducing the fabrication time and lowering the fabricating cost.

The invention provides a pasting machine to simultaneously paste a plurality of objects, which is conducive to reducing the fabrication time and lowering the fabrication cost.

The invention directs to a method of pasting a plurality of objects including the following processes. At least a first object and a second object are provided, wherein the first object has a first alignment mark thereon and the second object has a second alignment mark thereon. The first object and the second object are placed in parallel and the first alignment mark and the second alignment mark are aligned to each other. A first adhesive is applied on the first object and the second object such that a frame pattern formed by the first adhesive temporarily fixes the first object and the second object while the first alignment mark and the second alignment mark are still aligned to each other. A filling space is surrounded by the first object, the second object, and the frame pattern and the framed pattern has at least one injection hole and at least one exhausting hole located at two opposite sides. A second adhesive is filled in the filling space so that the first object and the second object are pasted to each other, wherein a viscosity of the first adhesive is greater than a viscosity of the second adhesive.

The invention further directs to a pasting machine including a positioning station and an adhesive accommodating tank. The positioning station has a plurality of positioning tuning components and an adhesive applying device. The positioning tuning components are used for adjusting the positions of a first object and a second object. The adhesive applying device is used for applying a first adhesive at the peripheries of the first object and the second object so as to primarily fix the first object and the second object. The adhesive accommodating tank is located at a downstream of the positioning station. The adhesive accommodating tank accommodates with a second adhesive such that the second adhesive can be filled between the first object and the second object primarily fixed.

In one embodiment of the invention, the viscosity of the first adhesive is from 0.6 Pa·s to 20 Pa·s.

In one embodiment of the invention, the first adhesive is a silicon gel.

In one embodiment of the invention, the first object and the second object are respectively a plate-like object.

In one embodiment of the invention, the process of filling the second adhesive in the filling space includes accommodating the second adhesive in an adhesive accommodating tank, immersing the first object and the second object temporarily fixed by the frame pattern in the adhesive accommodating tank, and exhausting an air in the filling space through the exhausting hole such that the second adhesive in the adhesive accommodating tank fills the filling spacing through the injection hole.

In one embodiment of the invention, the method of pasting a plurality of objects further includes curing the second adhesive after the second adhesive completely fills the filling space.

In one embodiment of the invention, the method of pasting a plurality of objects further includes scraping the second adhesive overflowed at the periphery of the first object and the periphery of the second object after the first object and the second object are pasted through the second adhesive completely filling the filling space.

In one embodiment of the invention, the method of pasting a plurality of objects further includes providing a third object having a third alignment mark, wherein the process of placing the first object and the second object in parallel further includes placing the first object, the second object, and the third object in parallel and aligning the first alignment mark, the second alignment mark, and the third alignment mark to one another.

In one embodiment of the invention, the process of forming the frame pattern by the first adhesive to temporarily fixed the first object and the second object further includes applying the first adhesive on the third object such that a second filling space is defined and surrounded by the frame pattern, the second object, and the third object.

In one embodiment of the invention, the injection hole and the exhausting hole of the frame pattern expose the filling space and the second filling space.

In one embodiment of the invention, the method of pasting a plurality of objects further includes filling the second adhesive in the second filling space so that the second object and the third object are pasted.

In one embodiment of the invention, the positioning station further has a position detector for detecting the locations of the first object and the second object.

In view of the above, a plurality of objects are temporarily fixed through the frame pattern formed by the first adhesive according to the method of pasting a plurality of objects in the invention, and then the second adhesive is filled in the filling space among the objects so as to simultaneous paste the objects. Accordingly, the fabrication time of pasting a plurality of objects is reduced, which renders the reduction of the fabrication cost.

In order to make the aforementioned and other features and advantages of the invention more comprehensible, embodiments accompanying figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a flowchart illustrating a method of pasting a plurality of objects according to an embodiment of the invention.

FIG. 2A through FIG. 2F schematically illustrate a method of pasting a plurality of objects according to an embodiment of the invention.

FIG. 3 is a schematic view of a pasting machine according to an embodiment of the invention.

### DESCRIPTION OF EMBODIMENTS

### Method of Pasting a Plurality of Objects

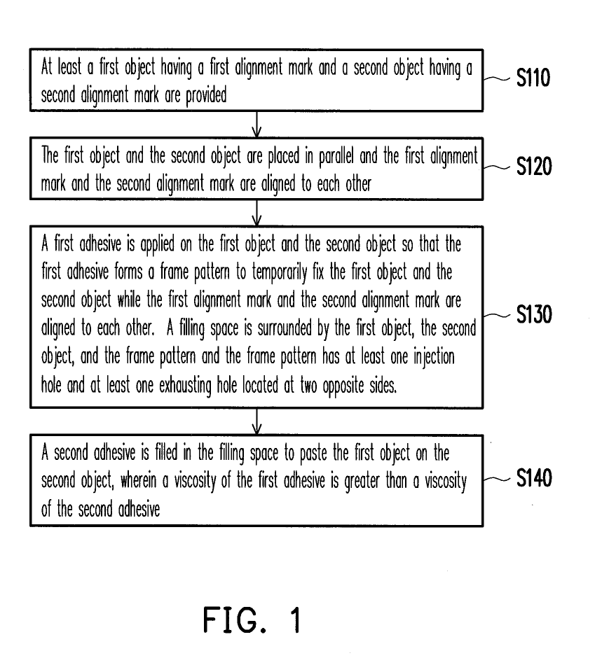

FIG. 1 is a flowchart illustrating a method of pasting a plurality of objects according to an embodiment of the invention. Referring to FIG. 1, the method of pasting a plurality of objects includes the following processes. First, at least a first object having a first alignment mark and a second object having a second alignment mark are provided (step S110). Next, the first object and the second object are placed in parallel and the first alignment mark and the second alignment mark are aligned to each other (step S120). Then, a first adhesive is applied on the first object and the second object so that the first adhesive forms a frame pattern to temporarily fix the first object and the second object while the first alignment mark and the second alignment mark are still aligned to each other. A filling space is surrounded by the first object, the second object, and the frame pattern and the frame pattern has at least one injection hole and at least one exhausting hole located at two opposite sides (step S130). Thereafter, a second adhesive is filled in the filling space to paste the first object on the second object, wherein a viscosity of the first adhesive is greater than a viscosity of the second adhesive (step S140). It is noted that the above mentioned method is taken as an example depicting the pasting of merely one first object and one second object to illustrate the scope of the present embodiment. Nevertheless, in other embodiments, the method can be used for pasting more than three objects.

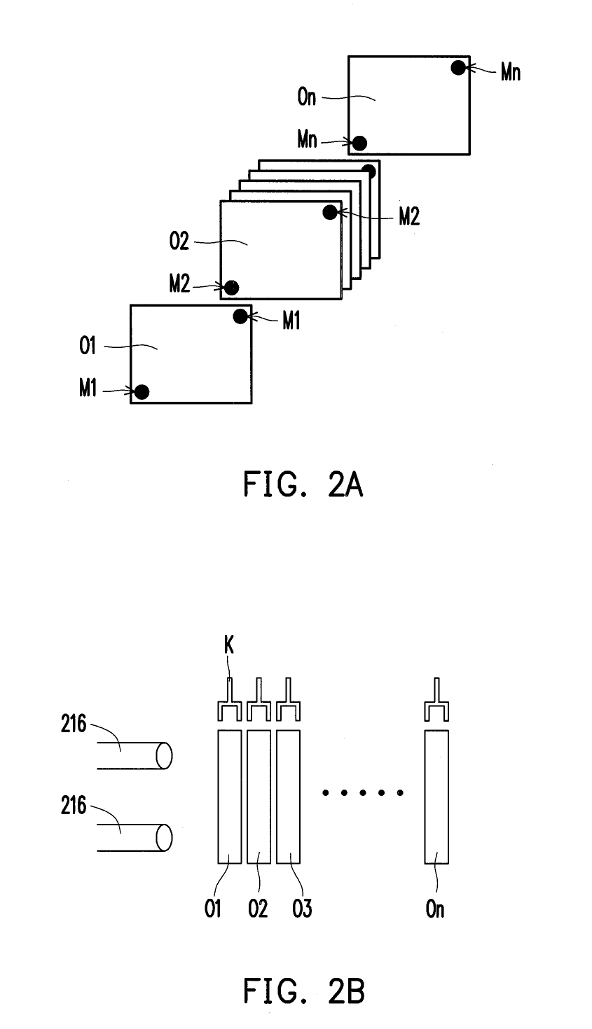

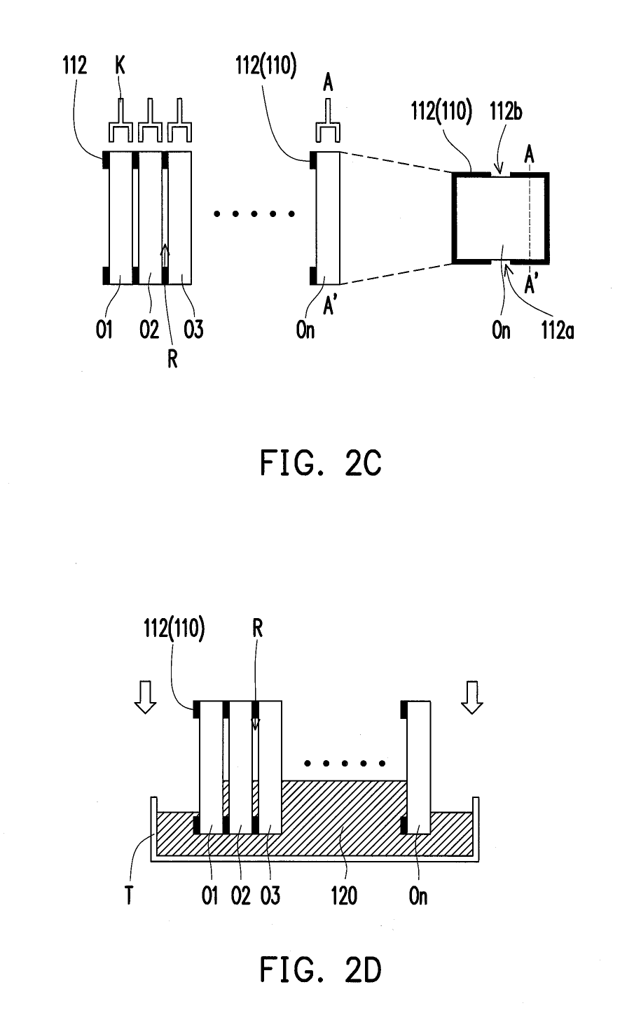

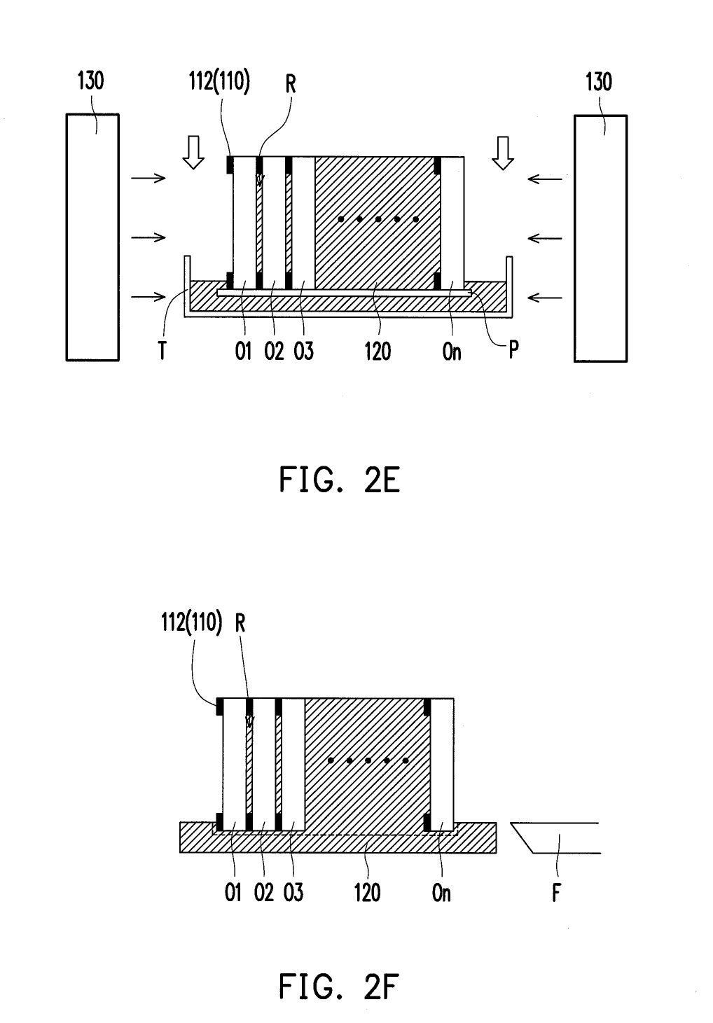

For clearly depicting the method of pasting a plurality of objects according to one embodiment of the invention, the following descriptions are provided accompanying with the drawings of FIG. 2A through FIG. 2F. Referring to FIG. 2A, n objects respectively having alignment marks are provided first, and herein n is an integer larger than 2. Specifically, the first object O1 has the first alignment mark M1, the second object O2 has the second alignment mark M2, the third object O3 has the third alignment mark M3, . . . and so on. In the present embodiment, the objects O1˜On can respectively be a plate-like object. For instance, the objects can be a cover lens, a touch panel, a display panel, an E-paper, a 2D to 3D switching panel, a waterproof type backlight module, other object to be pasted, or a combination thereof. The alignment mark can have the pattern of a circle, a rectangle, a diamond, a cross, or other shapes.

Referring to FIG. 2A and FIG. 2B, the first object O1, the second object O2, . . . and the n^{th} object On are arranged in parallel and the first alignment mark M1 and the second alignment mark M2 are first aligned to each other. After the alignment of the first alignment mark M1 and the second alignment mark M2, the third alignment mark M3 on the third object O3 is aligned to the second alignment mark M2 and the n^{th} alignment mark Mn on the n^{th} object On is sequentially aligned to the former (n−1)^{th} alignment mark M(n−1) on the (n−1)^{th} object O(n−1). In specific, the foregoing process can be performed automatically or manually to place the objects O1˜On in parallel on the machine, wherein the machine is configured with the positioning tuning components K so that the positions of the objects O1˜On on the machine can be adjusted through the positioning tuning components K. In the process, the alignment marks on the objects can be read through the position detector 216 such as a CCD (Charge Coupled Device) and determined through an artificial intelligence. Then, the locations of the objects O1˜On are adjusted through the positioning tuning components K such that the alignment marks M1˜Mn of the objects O1˜On can be aligned to one another.

Referring to FIG. 2C, the first adhesive 110 is applied on the peripheries of the objects O1˜On so that the first adhesive 110 forms a plurality of frame patterns 112 temporarily fixing the objects O1˜On. During the applying of the first adhesive 110, the alignment marks M1˜Mn of the objects O1˜On as shown in FIG. 2A are still aligned to one another, wherein a filling space R is surrounded and defined by the (n−1)^{th} object O(n−1), the n^{th} object On, and the frame pattern 112 located between the (n−1)^{th} object O(n−1) and the n^{th} object On while n is an integer larger than or identical to 2. In addition, each of the frame patterns 112 has an injection hole 112a and the exhausting hole 112b located at two opposite sides. Namely, the configuration of the frame pattern 112 separates any two adjacent objects O1˜On in a distance to define the filling space R.

It is noted that the injection hole 112a and the exhausting hole 112b of each frame pattern 112 expose the corresponding filling space R. The first adhesive 110 according to the present embodiment can be silicon gel or other suitable adhesion material and the viscosity of the first adhesive 110 can preferably be 0.6 Pa·s to 20 Pa·s. For instance, the adhesion material capable of being served as the first adhesive 110 includes, but not limits to KE-3423, KE-3475, KE-3495, KE-4895, KE-3424G, KE-1824, or X-32-1964. Owing to the high viscosity, the first adhesive 110 can form the frame pattern 112 between any two adjacent objects O1˜On and be not liable to overflow or fill into the filling space R. Accordingly, the first adhesive 110 in the present embodiment can temporarily fix the objects O1˜On in the corresponding relationship rather than permanently and steadily fix the objects O1˜On.

Referring to FIG. 2D, the second adhesive 120 is filled into the filling spaces R so that the first object O1, the second object O2, . . . and the n^{th} object On are pasted with one another. The process of filling the second adhesive 120 into the filling spaces R includes accommodating the second adhesive 120 in the adhesive accommodating tank T through pouring, injecting, or the like and immersing the objects O1˜On temporarily fixed by the frame patterns 112 in the adhesive accommodating tank T. Thereafter, the air in the filling spaces R is exhausted through the exhausting holes 112b as shown in FIG. 2C so that the second adhesive 120 in the adhesive accommodating tank T can be filled in the filling spaces R through the injection holes 112a as shown in FIG. 2C. In other words, the second adhesive 120 in the adhesive accommodating tank T can be filled in the filling spaces R by the physical effects such as the siphon effect and the pressure variance.

In the present embodiment, the viscosity of the first adhesive 110 is greater than the viscosity of the second adhesive 120. Accordingly, the second adhesive 120 can be rapidly filled in the filling spaces R through the siphon effect and the pressure variance due to the lower viscosity. The second adhesive 120 in the present embodiment can be a thermal curable adhesive, a irradiation curable adhesive, or other adhesion material.

Referring to FIG. 2E, the second adhesive 120 in the filling spaces R is cured. When the second adhesive 120 is a irradiation curable adhesive, the light source 130 is used for providing light irradiating on the objects O1˜On to cure the second adhesive 120 among the objects O1˜On so as to simultaneously paste the objects O1˜On. When the second adhesive 120 is a thermal curable adhesive, a heat source can be used for heating the objects O1 and On located at two sides to cure the second adhesive 120 among the objects O1˜On so as to simultaneously paste the objects O1˜On together. During the process of curing the second adhesive 120 among the objects O1˜On, a stopping plate P can be configured at a side of the assembly of the objects O1˜On immersed in the adhesive accommodating tank T to prevent the second adhesive 120 in the adhesive accommodating tank T from being cured. In addition, the curing process can be determined according to the property of the second adhesive 120 in the present embodiment. A heating process can be adopted to cure the second adhesive 120 when the second adhesive 120 is a thermal curable adhesive. A light irradiating process can be adopted to cure the second adhesive 120 when the second adhesive 120 is a irradiation curable adhesive. In other embodiments, the heating process and the light irradiating process can be simultaneously selected to cure the second adhesive 120. According to the process depicted in the present embodiment, a plurality of objects O1˜On can be simultaneously pasted together, which is conducive to reducing the fabrication time of pasting the objects O1˜On and further lowering the fabrication cost.

In addition, after the second adhesive 120 in the filling spaces R is cured, a portion of the second adhesive 120 may overflow and remain on the peripheries of the objects O1˜On. Herein, a cutting tool F can be used for scraping the residual and overflowed second adhesive 120 on the peripheries of the objects O1˜On as shown in FIG. 2F or a chemical solution capable of dissolving the second adhesive 120 can be used for removing the residual and overflowed second adhesive 120 on the peripheries of the objects O1˜On. Certainly, if the first adhesive 110 partially overflows and remains on the peripheries of the objects O1˜On, the residual and overflowed first adhesive 110 can be further removed in the present embodiment.

### Pasting Machine

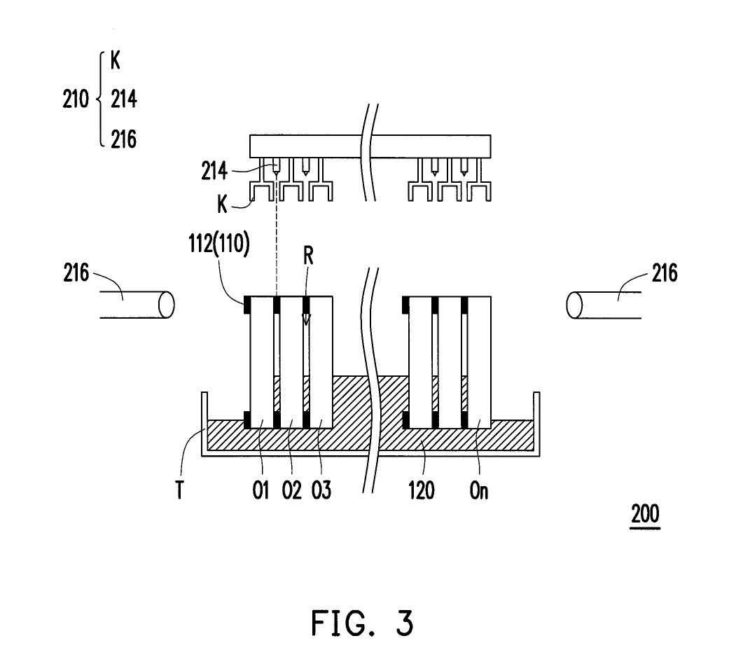

FIG. 3 is a schematic view of a pasting machine according to an embodiment of the invention. The pasting machine 200 according to the present embodiment includes a positioning station 210 and an adhesive accommodating tank T. The positioning station 210 has a plurality of positioning tuning components K and an adhesive applying device 214. The positioning tuning components K are respectively used for adjusting the locations of the objects O1˜On and the adhesive applying device 214 is used for applying the first adhesive 110 on the peripheries of the objects O1˜On so as to primarily fix the objects O1˜On together. The adhesive accommodating tank T is located at a downstream of the positioning station 210, and the adhesive accommodating tank T accommodates with the second adhesive 120 such that the second adhesive 120 can be filled among the objects O1˜On primarily fixed by the first adhesive 110. In the present embodiment, the positioning station 210 can further has a position detector 216 such as a CCD for detecting the locations of the objects O1˜On. A plurality of objects O1˜On can be simultaneously pasted together by using the pasting machine 200, which is conducive to reducing the fabrication time of pasting the objects O1˜On and further lowering the fabrication cost.

In summary, a plurality of objects are temporarily fixed through the frame patterns among the objects according to the method of pasting a plurality of object in the invention, then the second adhesive is filled in the filling space among the objects, and the second adhesive is subsequently cured so as to simultaneously paste the objects. Accordingly, the fabrication time of pasting a plurality of objects is reduced, which renders the reduction of the fabrication cost.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A method of pasting a plurality of objects, comprising:
providing at least a first object and a second object, wherein the first object has a first alignment mark thereon and the second object has a second alignment mark thereon;
placing the first object and the second object in parallel and aligning the first alignment mark and the second alignment mark to each other;
applying a first adhesive on the first object and the second object, such that the first adhesive forms a frame pattern to temporarily fix the first object and the second object while the first alignment mark and the second alignment mark are aligned to each other, wherein a filling space is defined and surrounded by the first object, the second object, and the frame pattern and the frame pattern has at least one injection hole and at least one exhausting hole located at two opposite sides of the frame pattern; and
filling a second adhesive in the filling space to paste the first object on the second object, wherein a viscosity of the first adhesive is greater than a viscosity of the second adhesive.

2. The method of pasting a plurality of objects as claimed in claim 1, wherein the viscosity of the first adhesive is from 0.6 Pa·s to 20 Pa·s.

3. The method of pasting a plurality of objects as claimed in claim 2, wherein the first adhesive is a silicon gel.

4. The method of pasting a plurality of objects as claimed in claim 1, wherein the first object and the second object are respectively a plate-like object.

5. The method of pasting a plurality of objects as claimed in claim 1, wherein the process of filling the second adhesive in the filling space comprising accommodating the second adhesive in an adhesive accommodating tank, immersing the first object and the second object temporarily fixed by the frame pattern in the adhesive accommodating tank, and exhausting an air in the filling space through the exhausting hole such that the second adhesive in the adhesive accommodating tank fills the filling spacing though the injection hole.

6. The method of pasting a plurality of objects as claimed in claim 1, further comprising curing the second adhesive after the second adhesive completely fills the filling space.

7. The method of pasting a plurality of objects as claimed in claim 1, further comprising scraping the second adhesive overflowed at the periphery of the first object and the periphery of the second object after the first object and the second object are pasted through the second adhesive completely filling the filling space.

8. The method of pasting a plurality of objects as claimed in claim 1, further comprising providing a third object having a third alignment mark, wherein the process of placing the first object and the second object in parallel further comprises placing the first object, the second object, and the third object in parallel and aligning the first alignment mark, the second alignment mark, and the third alignment mark to one another.

9. The method of pasting a plurality of objects as claimed in claim 8, wherein the process of forming the frame pattern by the first adhesive to temporarily fix the first object and the second object further comprising applying the first adhesive on the third object such that a second filling space is defined and surrounded by the frame pattern, the second object, and the third object.

10. The method of pasting a plurality of objects as claimed in claim 9, wherein the injection hole and the exhausting hole of the frame pattern expose the filling space and the second filling space.

11. The method of pasting a plurality of objects as claimed in claim 9, further comprising filling the second adhesive in the second filling space so that the second object and the third object are pasted.

12. A pasting machine, comprising:
a positioning station having a plurality of positioning tuning components and an adhesive applying device, the positioning tuning components being for adjusting locations of a first object and a second object, and the adhesive applying device being for applying a first adhesive at peripheries of the first object and the second object so as to primarily fix the first object and the second object; and
an adhesive accommodating tank located at a downstream of the positioning station, the adhesive accommodating tank accommodating with a second adhesive such that the second adhesive is filled between the first object and the second object primarily fixed by the first adhesive.

13. The pasting machine as claimed in claim 12, wherein the positioning station further comprises a position detector for detecting the locations of the first object and the second object.
